(19) United States
(12) Patent Application Publication
(10) Pub. No.: US 2006/0018328 A1
(43) Pub. Date: Jan. 26, 2006

(54) Method and system for powerline networking

(75) Inventors: Nirmal Mody, North Wales, PA (US); Brian J. Martone, Mantua, NJ (US); Jeffrey W. Austin, Audubon, PA (US); Richard C. Gasloli, Downingtown, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 10/897,903

(22) Filed: Jul. 23, 2004

(51) Int. Cl. H04L 12/28

(52) U.S. Cl. 370/401; 370/463

(57) ABSTRACT

A method and system for powerline networking. The method and system include an adapter and a gateway connected to powerlines. The gateway is operable for configuring the adapter for powerline networking by communicating configuration signals to the adapter over the powerlines. A powerline network is defined by the configuring of the adapter to communicate with the gateway over the powerlines.

### BACKGROUND OF THE INVENTION

1. Field of the Invention

The present invention relates to systems and methods for powerline networking that utilize powerlines to communicate signals between electrical devices.

2. Background Art

Powerline networking relates to a network infrastructure that utilizes powerlines to communicate signals between electrical devices. The powerlines can be those located in a building, a home, or other environment where a common set of electrical wiring is used to provide electrical power.

The HOMEPLUG ALLIANCE is a not-for-profit corporation formed to create an open infrastructure for high speed home powerline networking products and services. Its mission is to enable and promote rapid availability, adoption and implementation of cost effective, interoperable and standards-based home powerline networks and products.

The HOMEPLUG ALLIANCE has developed a strict certification program to ensure that products for powerline networking from different member companies work together. Any products that pass this program are issued the HOMEPLUG Certification Mark. The certification process tests each product to make sure it works effectively in homes of varying ages, sizes, levels, and with differing types of electrical service.

There are numerous HOMEPLUG compliant adapters for powerline networking. In general, these adapters include a first interface for interfacing to the powerline, such as through a wall outlet, and a second interface for interfacing to an electrical device that desires to communicate over the powerlines, such as with an Ethernet port. The HOMEPLUG adapters exchange signals between the electronic device and the powerlines, and other devices connected to the powerlines, to create a powerline network.

The adapters are configured by the manufacturer with a default password that limits the adapter to exchanging encryption keys with other adapters connected to the powerlines that share the same password. The exchanged encryption keys are used by the adapters for authentication such that the authenticated adapters are able to set up an Ethernet bridge or other communication means over the powerlines for the transfer of data therebetween. Such out of the box functionality is advantageous because it allows a user to easily create the powerline network. At the same time, the default password configuration is a security risk as other adapters having the same password can gain access to the powerline network without requiring permission of the user.

The known default passwords of the adapters can be removed and replaced with a user-selected password by connecting each adapter directly to a computer having a software program for configuring the adapters. The user-selected passwords are advantageous from a security perspective because they only permit authentication with other adapters that are configured with the same password so that unauthorized access to the network can be limited.

In addition to reconfiguring the adapters to include new user-specified passwords, the ability to connect the adapters to the computer allows the software application to reconfigure the operating settings of the adapter and/or the powerline network. For example, the adapter may include a wireless interface that allows the adapter to broadcast wireless signals to other devices, wherein the software application can be used to configure the wireless settings of the adapter, such as to configure its wireless encryption settings.

Each time the user desires to change the password or the settings of the adapter, it must be connected directly to the computer with the appropriate software application. This entails that the user will have to configure each adapter independently by unplugging each adapter and plugging it into to computer with the software application. Additionally, if the adapter is a wireless access point, the user may have to configure the wireless encryption settings through means other than the software application on the computer, such as through a user interface on the adapter. This decentralized control and processing is inconvenient. Moreover, the independent connection of the adapter to the computer typically only permits one adapter to be connected to the computer at a time, which can make it difficult for the user to synchronize multiple adapters. Furthermore, the decentralized control makes it even more difficult for internet service providers (ISP) to assist the user with configuring and monitoring the operation of the adapters and the powerline network because the ISP typically cannot access the user's computer to view the configuration of the adapters and/or the network settings. Accordingly, what is needed is a more user-friendly means for configuring and monitoring operation of the adapters and the powerline network.

### SUMMARY OF THE INVENTION

It is, therefore, an object of the present invention to provide an invention for powerline networking that overcomes the above-identified shortcomings of the prior art.

The present invention contemplates a number of features and configurations for powerline networking, including a system and method for powerline networking over a plurality of powerlines wherein a powerline network is created through communications over the powerlines. In accordance with one aspect of the present invention, the powerline network is created by connecting a gateway to the powerlines and using the gateway to communicate with an adapter connected to the powerlines such that the gateway communicates signals over the powerlines to the adapter for configuring the adapter to communicate over the powerlines.

In accordance with one aspect of the present invention, the adapters are HOMEPLUG compliant adapters that include a first interface for interfacing with the powerlines and a second interface for interfacing with a secondary device. The first interface can include any number of features, including a hard-wire connection to the powerlines, a two or three pronged plug for plugging into a conventional wall outlet to the powerlines, and the like. The second interface can include any number of features as well, including an Ethernet port for connecting to an internet network card of the secondary device, a wireless access feature for broadcasting wireless signals to a wireless network card of the secondary device, and the like.

In accordance with one aspect of the present invention, the gateway includes a modem or other communication device for communication with a remote network that is separate and independent from the powerline network. Preferably, the connection is such that the gateway can act as router to permit communication between the adapters and the remote network, which can be an Internet Service Provider (ISP).

In accordance with one aspect of the present invention, the gateway is configured with a gateway application that controls operation of the gateway, including configuring the adapter for communication over the powerlines by controlling the signals communicated by the gateway over the powerlines to the adapter. The configuring of the adapter preferably includes specifying protocols for the adapter so that the adapter can communicate with the gateway and other devices connected to the powerline network. Preferably, the gateway includes a user interface, such as a touch-screen, that permits a user to interact directly with the gateway for controlling the operation thereof, for inputting data thereto, and for receiving messages therefrom.

In accordance with one aspect of the present invention, the configuring of the adapter is protected by security features to insure only verified adapters are configured for operation with the powerline network. Preferably, the verification requires a user to input information into the gateway that confirms authenticity of the adapter such that on-site access to the gateway is required in order to configure the adapter to the powerline network. One feature for verifying the adapter can include requiring the user to input a password into the gateway for the adapter, such that the gateway transmits an authentication request message to the adapter, wherein the adapter compares the inputted password to a factory specified password assigned to the adapter by its manufacturer. Another feature for verifying the adapter can include requiring the user to input a serial number for the adapter, such that the gateway transmits the serial number in the authentication request, wherein the adapter compares the inputted serial number to a factory specified serial assigned to the adapter.

The advantages of the present invention are numerous, including enhanced security provided by requiring the user to input the default password and/or serial number of the adapter into the gateway, as it requires the user to have on-site access, either physical or through an authorized remote network, to the gateway in order to authenticate an adapter. Another advantage is that the gateway can configure the adapters over the powerline network without requiring the adapters to be connected directly to the computer with the appropriate software utility. Another advantage is that the gateway provides centralized control through communications over the powerlines, whereby the configuration and settings of the adapters can be easily changed without requiring the user to disconnect the adapters from the powerline, such as to change the network password and/or to change security protocols, such as for wireless communication. Moreover, remote access can be provided to the gateway over a remote network connected thereto for performing troubleshooting and other functions, so that a technician of an ISP or other entity can connect to the gateway over the remote network to assist with monitoring and configuring the powerline network and to perform upgrades thereto.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a system for powerline networking in accordance with one aspect of the present invention;

FIG. 2 illustrates a flowchart of a method for configuring a powerline network in accordance with the present invention;

FIG. 3 illustrates a flowchart of a method for configuring an adapter in accordance with one aspect of the present invention; and

FIG. 4 illustrates a flowchart of a method for configuring an adapter in accordance with one aspect of the present invention.

### DETAILED DESCRIPTION OF THE PREFERRED EMBODIMENT(S)

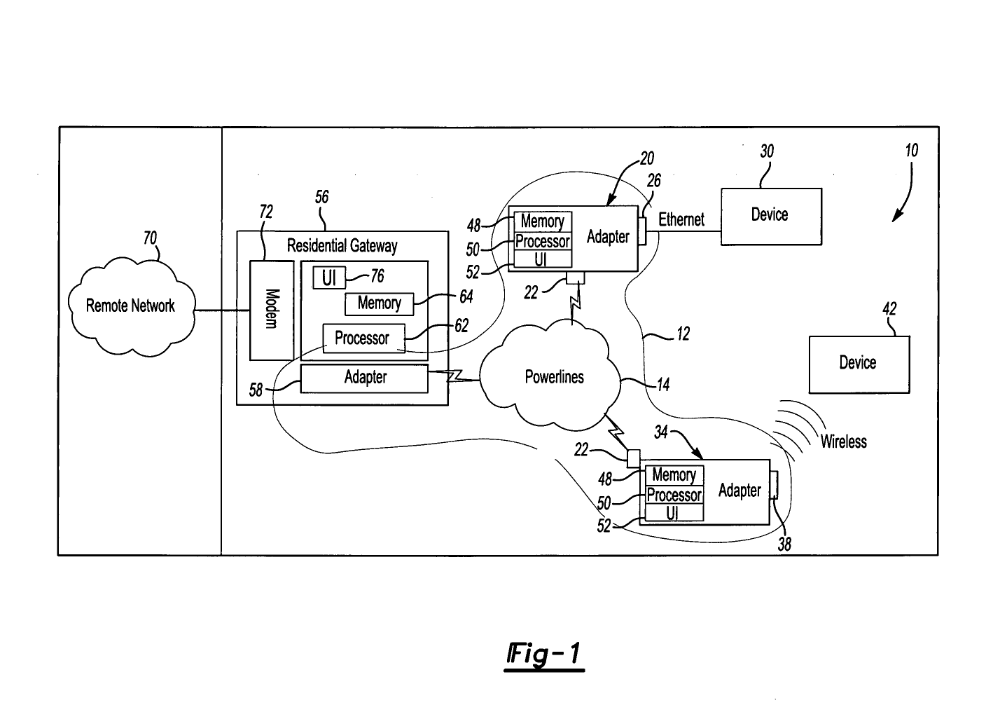

FIG. 1 illustrates a system 10 for powerline networking in accordance with one aspect of the present invention. The system 10 creates a powerline network 12 by communicating signals over powerlines 14. The powerlines 14 can be those located in a building, a home, or other environment where a common set of electrical wiring is used to provide electrical power.

Of course, the present invention is not limit to home powerlines, and other powerlines are contemplated. Moreover, the present invention is not limited to a particular powerline network configuration. The present invention contemplates any number of network configurations, including bus, ring, star, or star-bus networks, and the like.

The system 10 is configured so that computer and network signals can be broadcasted over the electrical powerlines 14 to nodes or other entry points on the network 12 through which various electronic devices can connect to the powerlines 14 for networking. The present invention contemplates a number of features and configurations for the entry points, including a HOMEPLUG certified adapter that is connected through a wall outlet to the powerlines 14.

For example, a first adapter 20 is configured with a standard two or three pronged plug interface 22 for insertion into a wall outlet through which the adapter 20 can communicate with the powerlines 14. The adapter 20 is further configured with a second interface 26 having an Ethernet output port into which a printer, a hub, a computer, or any other secondary electrical device 30 having an Ethernet compatible network interface card can be connected to communicate with the powerline network 12.

A second exemplary adapter 34 is configured with the standard two or three pronged plug interface 22 for insertion into a wall outlet through which the adapter can communicate with the powerline network 12. The adapter 34 is further configured with a wireless access feature 38 that allows the adapter 34 to broadcast wireless signals. The wireless signals allow a secondary device 42 having a wireless network card to exchange wireless signals with the adapter 34 for communication with the powerline network 12.

The present invention describes the adapters 20 and 34 as including two or three prong interfaces for connecting to the powerlines 14 through a wall outlet, however, the present invention is not limited to these types of adapters. Any type of adapter that is capable of communication over the powerlines 14, regardless of whether the adapter includes a two or three pronged interface, and regardless of whether the adapter meets the requirements of the HOMEPLUG alliance, is contemplated. An adapter in accordance with the present invention can include any connecting means for connecting to the powerlines 14, including a direct hard-wire, a light socket-type-fixture, a transformer, an electric discharge device, and the like. Moreover, the adapter can include any type of interface for communicating with the electric device connected thereto, including the above-described Ethernet and wireless interfaces, and further including USB, Firewire (IEEE1394), digital video interface (DVI), coax, RJ-11, Bluetooth, high-definition multimedia interface (HDMI), fiber optic, and the like. Furthermore, although two adapters 20 and 34 are shown and described herein, it is understood that any number of adapters can be used in accordance with the present invention.

Each adapter 20 and 34 can include a memory 48 and a processor 50 for executing an adapter application that controls operation of the adapter. Preferably, each adapter 20 and 34 is configured to operate according to a simple object access protocol (SOAP) having extensible markup language (XML) format messaging to facilitate network comnunication. In addition, each adapter preferably includes a serial number and a media access control (MAC) address or other unique identifiers assigned to it by the manufacturer. The serial number provides a unique identifying number of the adapter based on its manufacturer or product type. The MAC Address is a hardware address which uniquely identifies a node. It is programmed into the network interface of the adapter that allows the adapter to be identified on the powerline network 12.

The adapters 20 and 34 can be configured to include user-specified operating settings, such as for Ethernet and wireless communication. Preferably, each adapter includes a user interface (UI) 52 that facilitates programming of the adapter settings by user, in additional to capabilities for receiving signals over the powerlines 14 for self-programming. The UI 52 can be used to provide a graphical user interface (GUI) having input fields and selection fields for inputting and selecting the operational settings for the adapter. A wireless configuration GUI can be provided to encrypt the wireless signals using a wired equivalent privacy (WEP) and/or Wi-Fi Protected Access (WPA) security protocol. The user selects the desired settings from the wireless configuration GUI.

The WEP is defined in the 802.11b standard. WPA is an improvement on WEP as it utilizes a mechanism for dynamically changing encryption keys. Both are designed to provide the same level of security as that of a wired connection, such as the Ethernet bridge described above. This is done because the wireless connection capabilities of the adapter are inherently less secure than the Ethernet bridge, as the Ethernet bridge is protected by the physicalities of its structure requiring a direct connection to the powerline 14 as opposed to the wireless connection that can be accessed by a user remotely located from the powerline system. The WEP and WPA aim to provide security by encrypting data over radio waves so that it is protected as it is transmitted from one end point to another.

A gateway 56 is connected to the powerlines 14 by an adapter 58 having capabilities similar to those described above for the adapters 20 and 34. The adapter 58 includes a two or three pronged plug or other device for connecting the gateway 56 to the powerlines 14. The adapter 58 is preferably embedded within the gateway 56 and configured to communicate with a processor 62. The present invention is not limited to the embedded adapter 58 and other connections to the powerlines 14 are contemplated, such as through a hard-wire connection.

The processor 62 operates in conjunction with a gateway software application stored in a memory 64 of the gateway 56 to control and manage network operations and access. The gateway 56 is used to configure each adapter that desires to join the powerline network 12 for network cornmunications. The configuration process is described below in more detail and generally relates to the gateway 56 receiving signals from the adapters 20 and 34 and replying thereto with signals for authenticating and configuring the adapters 20 and 34 to communicate over the powerlines 14. It is understood that the adapters 20 and 34 and the gateway 56 can be connected to the same powerline 14 or different powerlines 14 within the powerline network 12.

The processor 62 can control the gateway 56 to act as a router so as to exchange signals between a remote network 70 and the powerline network 12. The remote network 70 can be separate from and independent of the powerline network 12, such as a wide area network (WAN) of an Internet Service Provider (ISP). Preferably, the ISP is a cable service provider that communicates with the gateway 56 through a modem 72 embedded in the gateway 56. Of course, the present invention is not limited to the type of network connected to the gateway 56 or the means by which the network 70 is connected. In particular, the present invention contemplates a number of means for connecting the gateway 56 to the ISP or other WAN, including through a digital subscriber line (DSL), a satellite, a radio frequency transmitter, a fiber-optic cable, and the like.

The gateway 56 can include a user interface (UI) 76, such as a touch-screen display. The UI 76 can be controlled by the processor 62 to provide graphical menus and the like for display on the UI 76, which can be used for receiving input commands from the user and for outputting information to the user. The gateway 56 can also include other features, such as input and output ports for communication directly with the gateway 56 as opposed to communicating with the gateway 56 through the powerlines 14 and the adapter 58.

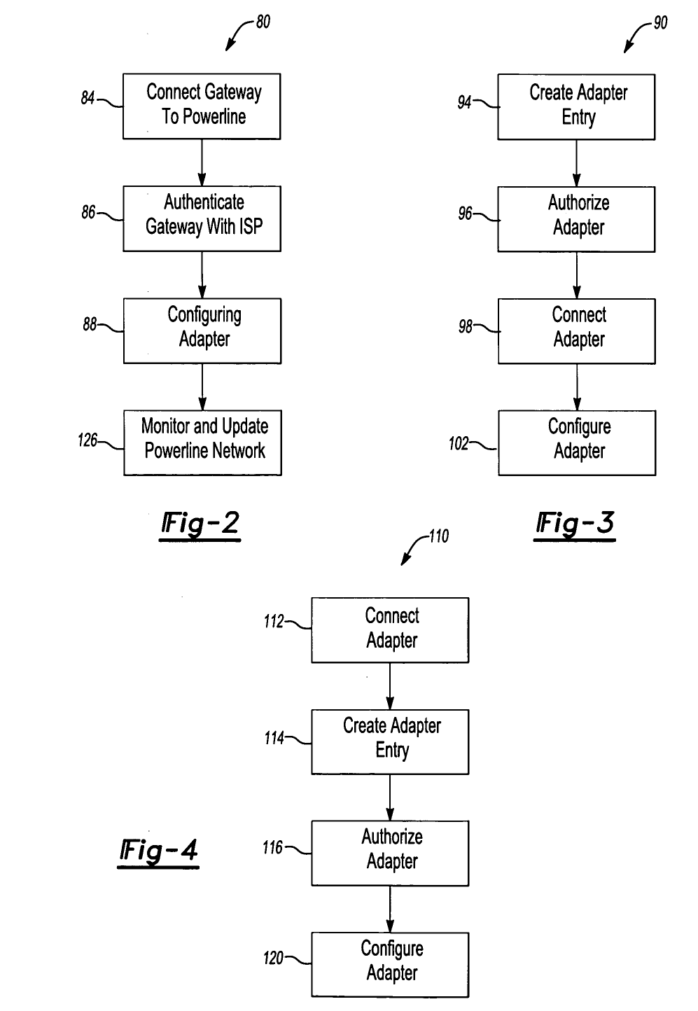

FIG. 2 illustrates a flowchart 80 that depicts a method for configuring the powerline network 12 in accordance with one aspect of the present invention. The method relates to configuring the powerline network 12 for operating in a home of a customer of a residential cable provider. The flowchart 80 relates to only one aspect of the present invention, and it is provided without intending to the limit the scope of the present invention.

Block 84 relates to connecting the gateway 56 to the powerlines 14. The connection can be made through a power-cord used to power the gateway 56 or with any other connection between the gateway 56 and the powerlines 14 that permits the adapter 58 of the gateway 56 to exchange signals over the powerlines 14.

Block 86 relates to authenticating the gateway 56 with the remote network 70 so that the gateway 56 can be connected to and communicate with the remote network 70. The authentication can include the gateway 56 sending an identification signal to the remote network 70 and the remote network 48 interpreting the signal. The remote network 70 provisions the gateway 56 to permit connection of the gateway 56 thereto. The authenticated gateway 56 is remotely accessible by the remote network 70 to permit a technician at the remote network 70 to view the settings and data stored on the gateway 56. The remote access can be accomplished through CableLabs DOCSIS and CableHome standards, which are programmed into the modem 72. Technicians from the remote network 70 can then access the gateway 56 to perform troubleshoot or other operations that may be needed to service and support the gateway 56. Advantageously, this is done remotely from a computer of the remote network 70 so that the provider of the remote network 70 can save the cost of transporting the technician to the customer's home.

Block 88 relates to configuring an adapter for access to the powerlines 14. The adapter can comprise any device that is capable of establishing an entry point to the powerline network 12, such as one or more of the adapters 20 and 34 described above. In accordance with one aspect of the present invention, the adapter comprises a HOMEPLUG compliant adapter. The adapter can include any number of features, and preferably includes a feature for connecting the adapter to the powerlines 14 and a feature for communicating with an electric device that desires to exchange signals over the powerlines 14.

FIGS. 3 and 4 illustrate two exemplary means for configuring the adapter to communicate over the powerline network 12 in accordance with the present invention.

FIG. 3 illustrates a flowchart 90 that depicts a method of statically configuring the adapter in accordance with one aspect of the present invention. The static configuration process allows the user to configure the gateway 56 to permit the adapter to join the powerline network 12 prior to connecting the adapter to the powerlines 14.

Block 94 relates to creating an adapter entry in the gateway 56 for the adapter based on the user inputting an adapter profile into the gateway 56 through the UI 76 for storage in the memory 64. The adapter profile can include a number of items, and preferably includes at least a serial number, MAC Address, default password, and device type of the adapter. The entry is communicated into a management information base (MIB) of the gateway 56, which is a database of data stored in the memory 64 that includes objects and instructions for the interaction of the gateway 56 with the adapter. The MIB can include profiles for known adapters and devices that specify the interactions of the gateway 56 with the adapter. This information can be accessed based on the device type and/or serial number inputted by the user. The gateway 56 can be configured to interrogate the inputted data and to prompt the user through the UI 76 to input additional information or to correct improperly entered data. Likewise, the remote network 70 can communicate with the gateway 56 to control the information displayed on the UI 76 so as to assist the user with inputting the data into the gateway 56 and/or the remote network 70 can troubleshoot the inputted data.

The adapter entry can further include user-specified operating settings, such as wireless settings, whereby the UI 76 can be used to facilitate selection of the user-specified settings. For example, the UI 76 can be configured to assist with creating wireless settings for the adapter (e.g. adapter 34) by providing a wireless configuration GUI. The wireless configuration GUI includes input fields and selecting fields for selecting the interaction of the wireless adapter with the network 14 and the gateway 56. The wireless configuration GUI is configured to encrypt the wireless signals using a wired equivalent privacy (WEP) and/or Wi-Fi Protected Access (WPA) security protocol or some other protocol, as described above. The user selects the desired settings from the wireless configuration GUI. The settings are stored on the gateway 56 for subsequent communication to the adapter.

Block 96 relates to the gateway 56 determining whether the adapter is authorized to access the powerline network 12. The authorization indicates that the adapter entry is created and that the required settings for the adapter are entered into the gateway 56. The authorization can be communicated to the user through the UI 76 or by some other indicator, such as by flashing an LED on the gateway 56. The authorization requires verification by the user, preferably by selection of a verification button on the UI 76. The verification button can be a simple accept or enter button on the UI 76 that confirms that the user has successfully created the profile for the adapter and/or the verification button can further include a password or other security feature to insure only authorized users are inputting data to the gateway 56. The authorization step is advantageous because it requires a user to be on-site with the gateway 56, thus preventing remote persons without access to the gateway 56 from authorizing adapters for communication with the powerline network 12. Of course, the present invention is not limited to on-site authorization whereby the user must directly interface with the gateway 56 to create and authorize the entry. Remote means, such as through remote network 70, are contemplated and preferably include at least some security so that only authorized users can create and authorize entries for the adapters.

Block 98 relates to connecting the authorized adapter to the powerlines 14. Once connected to the powerlines 14, the adapter is configured to broadcast a message to the gateway 56. The broadcasted message is a query from the adapter to the gateway 56 indicating the adapter desires to receive its configuration settings so that it can communicate with the powerline network 12 and the other devices connected thereto, such as with the gateway 56 and other adapters.

Block 102 relates to the gateway 56 configuring the authorized adapter for operation on the powerline network 12. The gateway 56 interrogates the broadcast from block 98 to locate the entry corresponding to the broadcasting adapter based on the adapter's MAC Address. The gateway 56 locates the entry and accesses the MIB to determine its response to the query broadcast. The gateway 56 can provide a message through the UI 76 or the LED (not shown) to indicate to the user that the broadcast message was received by the gateway 56 and that the adapter is requesting access to the network 12. If no entry if found for the broadcasting adapter, an entry is created and marked as Not Authorized and the gateway 56 ceases communication therewith as a security measure.

To begin the configuration, the gateway 56 communicates an encryption key request to the adapter for requesting an exchange of encryption keys between the gateway 56 and the adapter. The exchange of encryption keys is done to establish a communication protocol between the gateway 56 and the adapter. Once the encryption keys are exchanged, the gateway 56 transmits an authentication message containing the default password, serial number and a network password, entered by the user, to the adapter. The adapter compares the default password and serial number inputted into the gateway 56 to is factory settings for the default password and serial number. If the passwords and serial numbers match, the adapter responds with an accept message to the gateway 56. The gateway 56 responds to the accept message and re-exchanges encryption keys utilizing the network password.

The network password corresponds with the password used by the other devices connected to the powerline network 12 to authenticate their communications with each other. In essence, the adapter is able to communicate with any device connected to the powerline network 12 once the adapter changes its default password to the network password. Of course, the other devices connected to the network 12 can include other security features to limit communication therewith, however, this is not typically the case, as many HOMEPLUG compliant devices only require authentication by way of matching passwords. The matching of the passwords at the gateway 56 provides enhanced security for the powerline network 12 because it insures that only adapters having a matching password inputted to the gateway 56 receive the network password over the powerlines 14.

Once the encryption keys are exchanged using the network password, the gateway 56 requests the adapter's configuration profile. The adapter responds by sending a configuration profile message that includes settings and features of the adapter, which can include any number of options, and preferably at least includes security protocol settings of the adapter, like its wireless or Ethernet bridge settings. If the device type is determined to be an Ethernet bridge, the configuration is completed as the inherent security of the Ethernet bridge is sufficient due to it requiring a physical connection for communication. However, if the device type is a wireless access point, the gateway 56 sends a wireless configuration profile to the adapter which includes the wireless security settings inputted in block 94.

FIG. 4 illustrates a flowchart 110 that depicts a method of dynamically configuring gateway 56 to permit the adapter to join the powerline network 12 after the adapter is connected to the powerlines 14 in accordance with one aspect of the present invention. The dynamic configuration provides plug-in-play function whereby the adapter is plugged into the powerlines 14 before any data is inputted to the gateway 56.

Block 112 relates to connecting the adapter to the powerlines 14 prior to inputting data to the gateway 56 or otherwise notifying the gateway 56 of the adapter. The adapter is configured to broadcast an unconfigured message to the gateway 56 upon connection to the powerlines 14. The broadcasted message is a query from the adapter to the gateway 56 indicating that the adapter requests to access the powerline network 12. The broadcast message includes the adapter's MAC Address and device type.

Block 114 relates to the gateway creating an entry for the adapter in response to receiving the broadcast in block 112. The entry is created in the memory 64 of the gateway 56 and is used to control the interaction of the gateway 56 with the adapter, as described above. The gateway 56 sets the LED (not shown) to flash as a visual indicator to the end-user that an adapter is seeking to join the powerline network 12. To authenticate the adapter, the user inputs a serial number, a default password and other device settings depending on the device type to the gateway 56 through the UI 76.

Block 116 relates to authorizing the adapter, wherein the gateway 56 responds to the unconfigured message broadcasted by the adapter with an encryption key request to establish a communication link between the gateway 56 and the adapter. Once the encryption keys are exchanged, the gateway 56 transmits an authentication message containing the default password, serial number and a network password, entered by the user, to the adapter. The adapter compares the default password and serial number inputted into the gateway to is factory settings for the default password and serial number. If the passwords and serial numbers match, the adapter responds with an accept message to the gateway 56. The gateway 56 responds to the accept message and re-exchanges encryption keys utilizing the network password.

Once the encryption keys are exchanged using the network password, the gateway 56 requests the adapter's configuration profile. The adapter responds by sending a current profile message that includes settings and features of the adapter, which can include any number of options, and preferably at least includes security protocol settings of the adapter, like its wireless or Ethernet bridge settings. If the device type is determined to be an Ethernet bridge, the configuration is completed as the inherent security of the Ethernet bridge is sufficient due to it requiring a physical connection for communication. However, if the device type is a wireless access point, the gateway 56 sends a wireless configuration profile to the adapter which includes the wireless security settings inputted in block 114.

Returning to FIG. 2, once the adapter is configured in the block 88, whether by the methods shown in FIG. 3 or 4, or some other method, the powerline network 12 is created because at least one adapter is now configured to communication with the gateway 56 over the powerlines 14.

Block 120 relates to monitoring and updating the powerline network 12. Both the remote network 70, such as an ISP, and the gateway 56 provide monitoring functions. The ISP can download data to the gateway 56 and request data therefrom for monitoring and updating the gateway 56 and to perform system upgrades or troubleshooting. The gateway 56 can be configured to provide profiles, such as for the network, the gateway 56, and the adapters 20 and 34 to the ISP connected thereto over the remote control network 70. The profiles can provide settings, protocols, device tape information, and other data to the ISP so that the ISP can assist with troubleshooting and configuring the network 12, the gateway 56, and the adapters 20 and 34. Likewise, the gateway 56 can monitor for new adapters by polling for the authentication of new nodes.

The advantages of the present invention are numerous, including the ability to authenticate and configure the adapters 20 and 34 over the powerline network 12, without requiring the adapters to be connected directly to the gateway 56 or a computer. In addition, the gateway 56 provides centralized control, whereby the configuration and settings of the adapters can be easily changed without requiring the user to disconnect the adapters from the powerlines 14 by the gateway 56 broadcasting new configuration profiles to the adapters over the powerline network 12, such as to change the network password and/or to change security protocols, such as for wireless communication. Moreover, by providing remote access to the gateway 56 over the remote network 70, troubleshooting and other functions can be performed by a technician of an ISP or other entity to assist with monitoring the powerline network 12 and to perform upgrades thereto.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for powerline networking over a plurality of powerlines, the method comprising:
providing an adapter in communication with one of the plurality of powerlines;
providing a gateway in communication with one of the plurality of powerlines;
creating a powerline network between the gateway and the adapter by controlling the gateway to exchange signals with the adapter over the powerlines, the signals configuring the adapter for communication over the powerline network with the gateway and other devices connected thereto.

2. The method of claim 1 further comprising creating an entry for the adapter on a memory of the gateway, the entry specifying a network address, a serial number, and a default password for the adapter, the gateway utilizing the entry for configuring the adapter.

3. The method of claim 2 further comprising transmitting the serial number and default password from the gateway to the adapter, the adapter comparing the default password and serial number to a factory-specified default password and serial number of the adapter.

4. The method of claim 3 further comprising the adapter transmitting an accept message to the gateway if the serial number and default password broadcasted from the gateway to the adapter matches the factory specified default password and serial number of the adapter, the gateway broadcasting signals to the adapter to configure the adapter for communication over the powerline network if the accept message is received by the gateway.

5. The method of claim 4 wherein configuring the adapter for communication over the powerline network includes the adapter changing the default password to a network password broadcasted to the adapter from the gateway so as to permit the adapter to communicate over the powerline network with the gateway and other devices connected thereto.

6. The method of claim 2 wherein the entry is created in part dynamically by the adapter broadcasting an unconfigured message to the gateway over the plurality of powerlines, the unconfigured message including a network address and device type of the adapter, and wherein the entry is created in part by receiving a user-input default password and serial number at the gateway.

7. The method of claim 2 wherein the entry is created statically by receiving a user-input network address, device type, default address, and serial number for the adapter at the gateway.

8. The method of claim 7 wherein the network address, device type, default address, and serial number are received by a user interface on the gateway.

9. The method of claim 7 wherein the network address, device type, default address, and serial number are received at the gateway through a remote network.

10. The method of claim 1 wherein configuring the adapter includes the gateway sending a configuration profile to the adapter over the plurality of powerlines, the configuration profile specifying communication protocols for the adapter to communicate with the gateway over the powerlines.

11. The method of claim 10 wherein the configuration profile includes security protocols for communicating over the powerline network.

12. The method of claim 1 further comprising connecting the gateway to a remote network, the remote network being external to and independent of the plurality of powerlines.

13. The method of claim 12 further comprising controlling the gateway to exchange signals between the remote network and the powerline network so that a device interfaced with the adapter can communicate with the remote network by way of the powerline network.

14. The method of claim 12 further comprising outputting signals from the gateway to the remote network representing a profile of the adapter so that a device connected to the remote network can view the profile.

15. The method of claim 14 wherein viewing the profile includes troubleshooting the adapter.

16. The method of claim 12 further comprising outputting signals from the gateway to the remote network representing a profile of the powerline network so that a device connected to the remote network can view the profile.

17. The method of claim 16 wherein viewing the profile includes troubleshooting the powerline network.

18. The method of claim 1 further comprising creating an entry for the adapter on the gateway, the gateway utilizing the entry for configuring the adapter.

19. The method of claim 18 further comprising authenticating the adapter based on the entry prior to configuring the adapter.

20. The method of claim 19 wherein authenticating the adapter includes the gateway prompting the user to verify that the entry is properly created.

21. The method of claim 20 wherein the entry is properly created if a serial number, default password, network address, device type, and security settings are received at the gateway.

22. A system for powerline networking over the plurality of powerlines, the system comprising:
a gateway including a first interface for communication with the plurality of powerlines, the gateway configured with a processor and a memory that execute a gateway application, the gateway application controlling the gateway to send and receive signals through the first interface for managing communications over the powerlines; and
an adapter including a first interface for communication with a secondary device and a second interface for communication with the powerlines, the adapter including a processor and a memory that execute an adapter application, the adapter application controlling the adapter to exchange signals between the secondary device and the powerlines based on signals received over the powerlines from the gateway;
wherein the gateway and the adapter define a powerline network wherein signals are communicated between the gateway, the adapter, and the secondary device interfaced with the adapter.

23. The system of claim 22 wherein the gateway further includes a second interface for communication with a remote network, the remote network being external to and independent of the plurality of powerlines.

24. The system of claim 23 wherein the gateway controls an exchange of signals between the remote network and the powerline network so that the secondary device interfaced with the adapter can communicate with the remote network by way of the adapter and the gateway.

25. The system of claim 22 wherein the gateway outputs signals to the remote network representing a profile of the adapter so that a device connected to the remote network can view the profile.

26. The system of claim 25 wherein the profile includes information for troubleshooting the adapter.

27. The system of claim 23 wherein the gateway outputs signals to the remote network representing a profile of the powerline network so that a device connected to the remote network can view the profile.

28. The system of claim 27 wherein the profile includes information for troubleshooting the powerline network.

29. The system of claim 23 wherein the remote network is an Internet Service Provider (ISP).

30. The system of claim 23 wherein the second interface of the gateway is a modem.

31. The system of claim 22 wherein the gateway communicates a configuration profile over the plurality of powerlines to the adapter for managing a configuration of the adapter, the configuration of the adapter permitting the adapter to join the powerline network, wherein the configuration profile includes security protocols for communicating over the powerline network.

32. The system of claim 22 wherein the first interface of the adapter provides an Ethernet port for communicating with the secondary device.

33. The system of claim 22 wherein the first interface of the adapter provides a wireless access point for communicating with the secondary device.

34. The system of claim 22 wherein the gateway includes a user interface having a display, the user interface configured to receive inputs from a user for controlling operation of the gateway, the user interface further configured to output information to the user through the display.

35. A method for powerline networking over a plurality of powerlines, the powerlines comprising a plurality of electrical wires configured for transmitting electrical power, the method comprising:
configuring an adapter for connecting to one of the plurality of powerlines, the adapter configured to communicate signals over the powerlines;
configuring a gateway for connecting to one of a plurality of powerlines, the gateway configured to communicate signals over the powerlines; and
creating a powerline network between the gateway and the adapter over the plurality of powerlines by communicating signals for configuring the adapter from the gateway to the adapter over the powerlines, the powerline network permitting the gateway to communicate directly with the adapter.

36. The method of claim 35 further comprising configuring the gateway to transmit a serial number and a default password received at the gateway from the gateway to the adapter, and configuring the adapter to compare the default password and serial number to a factory-specified default password and serial number of the adapter.

37. The method of claim 36 further comrising configuring the adapter to broadcast an accept message to the gateway if the serial number and default password broadcasted from the gateway to the adapter matches the factory-specified default password and serial number of the adapter, and configuring the gateway to broadcast signals to the adapter to configure the adapter for communication over the powerline network if the accept message is received by the gateway.

38. The method of claim 35 further comprising configuring the gateway for communication with a remote network, the remote network being separate from and independent of the powerline network.

39. The method of claim 38 further comprising controlling operation of the gateway via the remote network to facilitate configuring the adapter.

40. The method of claim 35 further comprising controlling a user interface on the gateway to facilitate configuring the adapter.
